(19) United States
(12) Patent Application Publication
(10) Pub. No.: US 2018/0155179 A1
(43) Pub. Date: Jun. 7, 2018

(54) Flowable Substance Refill Container

(71) Applicant: COLGATE-PALMOLIVE COMPANY, New York, NY (US)

(72) Inventors: Stanislav JARACZ, Somerset, NJ (US); John CRAWFORD, Mahopac, NY (US); Arooj MUSTAFA, Collingswood, NJ (US)

(73) Assignee: COLGATE-PALMOLIVE COMPANY, New York, NY (US)

(21) Appl. No.: 15/367,230

(22) Filed: Dec. 2, 2016

(51) Int. Cl. B67D 7/02

(52) U.S. Cl. CPC B67D 7/0216; B67D 7/0288

(57) ABSTRACT

A refill dispensing container is disclosed that includes a body portion for containing a flowable substance, a neck portion that is connected to the body portion, a lid that is connected to the neck portion and that defines a hole, a dip tube that is connected to the lid and the hole and that is positioned within the body portion. The container can also include a transfer tube and a transfer nozzle connected to the transfer tube. The transfer tube can be deployed by sliding the transfer tube out of the dip tube, extending the transfer tube, or removing the transfer nozzle from a holder connected to the body portion. When the transfer tube is deployed and pressure is applied to the body portion, the flowable substance can flow from the container into an interior of the transfer tube and can be discharged via the transfer nozzle.

### BACKGROUND

A refill dispensing bottle is a bottle or other type of container from which a flowable substance (e.g., a liquid) may be dispensed to refill another container (hereinafter, “destination container”), such as a destination liquid hand soap pump bottle or a destination dish liquid bottle. The flowable substance may be, for example, liquid hand soap or dishwashing liquid. In many instances, the refill dispensing bottle is of a larger volume than the destination container (e.g., a liquid hand soap pump bottle), so that the destination container may be refilled with the flowable substance from the same refill dispensing bottle several times.

Consumers may desire to purchase refill dispensing bottles because the larger size of the bottle may result in the refill dispensing bottles being sold at a bulk price that is a better value than purchasing new, smaller, destination containers.

Additionally, consumers may desire to keep the destination containers “topped off,” because a full or near full container may appear more aesthetically pleasing then an almost full, half full, or almost empty container.

In order to refill the destination container, a consumer may hold a refill dispensing bottle in an inverted state over the destination container with a nozzle of the refill dispensing bottle facing down towards the destination container. Then, gravity can cause the substance to be discharged from the refill dispensing bottle into the destination container.

When using a refill dispensing bottle to refill a destination container with a substance that has a viscosity that is higher than water, such as liquid hand soap, the consumer can squeeze the sides of the refill dispensing bottle, causing pressure in the bottle. Thus, a combination of gravity and the pressure from squeezing can cause the substance to be discharged from the refill dispensing bottle into the destination container.

For a substance with a viscosity that is higher than water, such as liquid hand soap, the substance may take several minutes for sufficient volume of the substance to be dispensed from the refill dispensing bottle into the destination container. Holding the refill dispensing bottle in an inverted state over the destination container for several minutes can be difficult due to the weight of the bottle and the need to keep the refill dispensing bottle positioned over the destination container. Movement of the refill dispensing bottle or the destination container during the refill process can result in the substance being spilled or otherwise undesirably dispensed (e.g., the substance is dispensed from the refill dispensing bottle and does not flow into the destination container).

Thus, what is desired is an improved refill dispensing bottle that addresses these shortcomings, such as an improved refill dispensing bottle that enables a flowable substance (e.g., a liquid) to be dispensed without having to hold the refill dispensing bottle in an inverted state, to be dispensed without having to hold the refill dispensing bottle over the destination container, and/or to be dispensed while avoiding or minimizing undesired dispensing of the flowable substance (i.e., outside of the destination container).

### BRIEF SUMMARY

A refill dispensing bottle is disclosed. In an embodiment, the refill dispensing bottle can include a body portion that includes sidewalls that form a chamber for containing a flowable substance, a neck portion that is connected to the body portion, a lid that is connected to the neck portion and that defines a hole, a dip tube that is connected to the lid and the hole and that is positioned within the body portion, a transfer tube that passes through the hole and that is configured to slide in and out of the dip tube, and a transfer nozzle connected to the transfer tube. The dip tube and the transfer tube can form an expanded tube when the transfer tube is slid out of the dip tube, and, when pressure is applied to the sidewalls of the body portion, the flowable substance can flow from the chamber into an interior of the expanded tube and can be discharged via the transfer nozzle.

In some embodiments, the transfer nozzle can be a screw cap transfer nozzle.

In further embodiments, the lid can include a continuous inside thread or lugs that allows the lid to be screwed on to the neck portion.

In still further embodiments, the dip tube can extend to within 10 millimeters of a base portion of an interior of the body portion.

In some implementations, the flowable substance can be discharged into a destination container that is configured to hold a smaller volume of the flowable substance than the refill dispensing bottle.

In further implementations, the refill dispensing bottle can remain upright while the flowable substance is discharged.

In still further implementations, when the pressure is released from the sidewall, an amount of the flowable substance in the transfer tube can flow back into the body portion.

In other embodiments, a refill dispensing bottle can include a body portion that includes sidewalls that form a chamber for containing a flowable substance, a neck portion that is connected to the body portion, a lid that is connected to the neck portion and that defines a hole, a dip tube that is connected to the lid and the hole and that is positioned within the body portion, an expandable transfer tube that is connected to the lid, and a transfer nozzle connected to the expandable transfer tube. The dip tube and the expandable transfer tube can form an expanded tube when an end of the expandable tube is pulled away from the lid, and, when pressure is applied to the sidewalls of the body portion, the flowable substance can flow from the chamber into an interior of the expanded tube and can be discharged via the transfer nozzle.

In further embodiments, a refill dispensing bottle can include a body portion that includes sidewalls that form a chamber for containing a flowable substance, a neck portion that is connected to the body portion, a lid that is connected to the neck portion and that defines a hole, a dip tube that is connected to the lid and the hole and that is positioned within the body portion, a transfer tube that is connected to the lid and the hole, a screw cap transfer nozzle connected to the transfer tube, and a screw cap holder connected to the body portion. The transfer tube can be stored by screwing the screw cap transfer nozzle to the screw cap holder, and the transfer tube can be deployed by unscrewing the screw cap transfer nozzle from the screw cap holder. When the transfer tube is deployed and pressure is applied to the sidewalls of the body portion, the flowable substance can flow from the chamber into an interior of the dip tube and the transfer tube and can be discharged via the screw cap transfer nozzle.

Further areas of applicability of the present disclosure will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a front view of a refill dispensing bottle, according to an embodiment.

FIG. 2 depicts a front view of a refill dispensing bottle with an extended transfer tube, according to an embodiment.

FIG. 3 depicts a front view of a refill dispensing bottle and a destination container with an extended transfer tube of the refill dispensing bottle extending to the destination container, according to an embodiment.

FIG. 4 depicts a cross-sectional front view of a refill dispensing bottle along the plane of line 4-4 in FIG. 1, according to an embodiment.

FIG. 5 depicts a cross-sectional front view of a refill dispensing bottle with an extended transfer tube along the plane of line 5-5 in FIG. 2, according to an embodiment.

FIG. 6 depicts a front view of a refill dispensing bottle, according to an embodiment.

FIG. 7 depicts a front view of a refill dispensing bottle with an expandable tube and a destination container, according to an embodiment.

FIG. 8 depicts a front view of a refill dispensing bottle, according to an embodiment.

FIG. 9 depicts a front perspective view of a refill dispensing bottle, according to an embodiment.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

The embodiment(s) described herein further provide solutions to the problems related to transferring a flowable substance, (for example, a liquid, a fluid, or the like) from a first container into a second container, including problems such as, for example, having to hold the first container in an inverted state over the second container during the transfer and/or undesired dispensing of the flowable substance (e.g., outside of the destination container).

Although the disclosed embodiments describe bottles and associated devices used for refilling other containers, in some embodiments, the features and principles described below can be used with any type of container that can be used to transfer a flowable substance to a destination container.

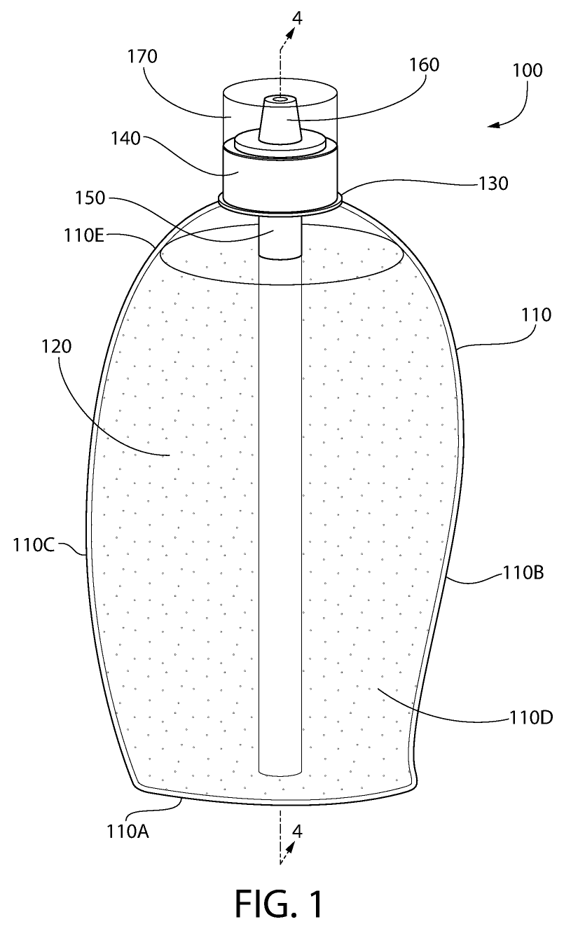

FIG. 1 depicts a front view of a refill dispensing bottle 100, according to an embodiment. The bottle 100 can include a body portion 110 defining a chamber that can contain a flowable substance 120. For example, the bottle 100 can contain between 50 to 60 fluid ounces (1500 to 1800 cubic centimeters (cc)) of the flowable substance 120. The flowable substance 120 may be, for example, a liquid, a foam, a gel, an emulsion, or a colloid. The flowable substance 120 can be various types of consumer-product liquids and fluids, such as, for example, a liquid hand soap, a dishwashing liquid, or any other fluid home care product, personal care product, or the like. In some embodiments, the flowable substance 120 can be flowable at room temperature and atmospheric pressure. Herein, “room temperature” can refer to a temperature of between 20 to 25 degrees Celsius, and “atmospheric pressure” can refer to a pressure at or near 101 kilopascals (kPa).

In some implementations, at room temperature and atmospheric pressure the flowable substance 120 may be more viscous than water. As an example, the flowable substance 120 can have a viscosity of between 100 and 25,000 Pa per second.

The body portion 110 can be made of plastic, including, for example, a thermoplastic. As used herein, a plastic can refer to, for example, polyethylene terephthalate (PET), high density polyethylene (HDPE), polyvinyl chloride (PVC), low density polyethylene (LDPE), polypropylene (PP), polystyrene (PS), or the like.

The body portion 110 can include a base portion 110A, two narrow sidewalls 110B and 110C, two wide sidewalls including a wide sidewall 110D and a second wide sidewall (not shown) that is similar to wide sidewall 110D, and a shoulder portion 110E. The two wide sidewalls (including the wide sidewall 110D) can be elastically flexible to allow a consumer to squeeze the refill dispensing bottle 100 to discharge the flowable substance 120, as described in further detail below. The base portion 110A, the two narrow sidewalls 110B and 110C, and the shoulder portion 110E can be more rigid than the two wide sidewalls, for example, by being thicker than the two wide sidewalls.

The bottle 100 can include a narrowed neck portion 130 that is connected to the shoulder portion 110E of the body portion 110, and that defines an opening through which the flowable substance 120 is dispensed from the bottle 100. The base portion 110A of the bottle 100 can be flat or substantially flat, and the bottle 100 may stand with the base portion 110A on a substantially flat and horizontal surface (e.g., a countertop) when not in use and/or when dispensing the flowable substance 120. As used herein, when the base portion 110A is positioned lower than the rest of the bottle 100, (e.g., when resting with the base portion 110A on a countertop), the bottle 100 can be described as “upright.” Further, as used herein, when the base portion 110A is not positioned lower than the rest of the bottle 110 (e.g., the base portion 110A is positioned higher than the rest of the bottle 110), the bottle 100 can be described as “inverted.”

The bottle 100 can include a lid 140 that can be made of plastic. In some embodiments, the lid 140 can be made of a plastic that is more rigid than, for example, the wide sidewall 110D.

In some implementations, the lid 140 can be have a screw closure design with a continuous inside thread or lugs that allows the lid 140 to be screwed on to the narrowed neck portion 130 to block the opening in the neck portion 130 and to provide a seal and/or barrier for the flowable substance 120 or to be screwed off of the narrowed neck portion 130. The narrowed neck portion 130 can, in such implementations, also include a continuous outside thread that allows the lid 140 to be screwed on or off.

In other implementations, the lid 140 may not be designed to be removed from the rest of the bottle 100 and can be sealed or otherwise adhered to the narrowed neck portion 130 without a thread or lugs or may be integral with the narrowed neck portion 130.

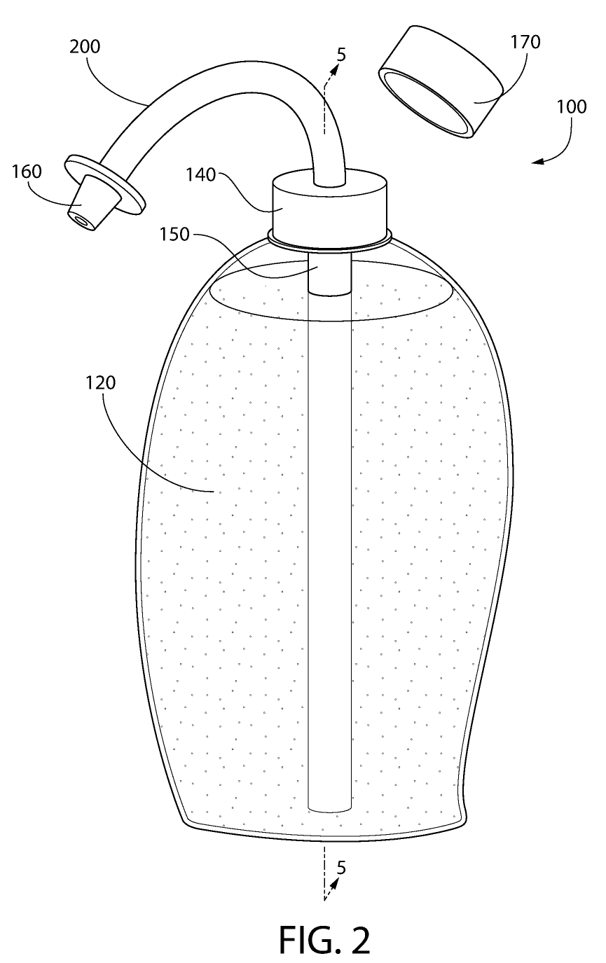

In some embodiments, the lid 140 can include a hole through which a transfer tube 200 (not shown in FIG. 1; see FIG. 2) may pass and slide, as described in further detail below.

In some implementations, the bottle 100 can additionally include a dip tube 150 connected to the lid 140 and extending within the body portion 110. The dip tube 150 can be a hollow tube composed of plastic and having a length that extends from the lid 140 to a point at or near the base portion 110A of the bottle 100. For example, the dip tube 150 can extend to and contact the base portion 110A or the dip tube 150 can extend to within a centimeter or a few millimeters of the base portion 110A. As a further example, the dip tube 150 can be in contact with the base portion 110A of the bottle 100, and can be bent or curved such that the straightened length of the dip tube 150 is larger than the distance from the lid 140 to the base portion 110A of the bottle 100.

In further implementations, the bottle 100 can also include a transfer nozzle 160. The transfer nozzle 160 can be composed of plastic and can be connected to the transfer tube 200. In some embodiments, the transfer nozzle 160 may be integral with the transfer tube 200. The transfer nozzle 160 can include an opening through which the flowable substance 120 can pass. For example, when pressure is applied to the wide sidewalls (including wide sidewall 110D) of the body portion 110, the flowable substance 120 can pass through the dip tube 150 and the transfer tube 200, and be dispensed out of the opening of the transfer nozzle 160. In various embodiments, the transfer nozzle 160 can be composed of a plastic that is more rigid than, for example, the wide sidewall 110D or the transfer tube 200 (as described in further detail below), and can be larger than the hole in the lid 140. Thus, the transfer nozzle 160 cannot pass through the hole in the lid 140 and can abut the top of lid 140 when in a storage configuration (e.g., as shown in FIG. 1).

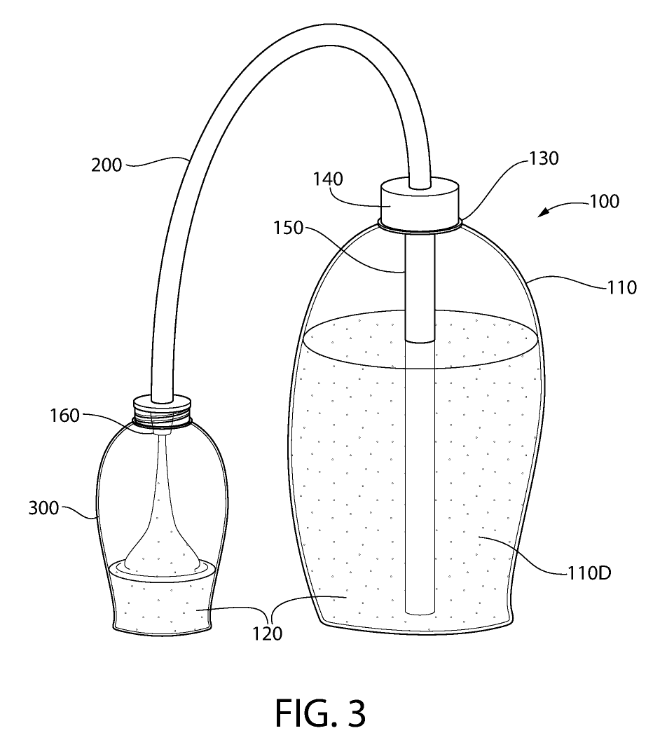

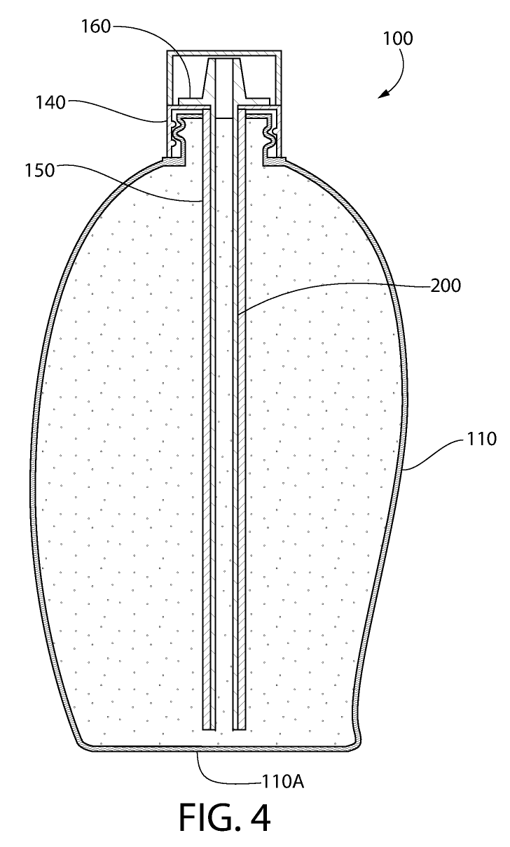

When in a storage configuration, (e.g., as shown in FIG. 1), in some implementations, the transfer tube 200 can be contained within the dip tube 150. In some embodiments, the exterior of the transfer tube 200 can abut or fit within the interior of the dip tube 150, and the transfer tube 200 and the dip tube 150 can be in a telescopic configuration such that the transfer tube 200 can slide along the interior of the dip tube 150, creating an extendable tube that bridges the distance between the refill dispensing bottle 100 and a destination container 300 and allows the flowable substance 120 to be discharged from the body portion 110 into the destination container 300 (as described in further detail below with respect to FIGS. 3 and 4).

In some embodiments, the bottle 100 can further include a cap 170. The cap 170 can be composed of plastic, can be connected to the lid 140, (e.g., by a hinge (not shown)), and can cover the transfer nozzle 160 when the bottle 100 is in a storage configuration. In some implementations, the cap 170 can be composed of a transparent or semitransparent plastic, and the transfer nozzle 160 can be visible through the plastic of the cap 170. In other implementations, the cap 170 can be translucent, opaque, etc. In further implementations, the cap 170 and the lid 140 can be designed in a mating configuration, such that the cap 170 can connect to the lid 140, creating at least a partial seal, and the cap 170 can be removed from the lid 140 for use and then returned to the mated configuration for storage. For example, the cap 170 may have a lip that snaps into a groove of the lid 140 or may have an internal thread that screws into a thread on an exterior of the lid 140.

The at least partial seal between the cap 170 and the lid 140 can, in some embodiments, prevent or diminish exposure of the flowable substance 120 to, for example, air, oxygen, etc., thus preventing or diminishing degradation of the flowable substance 120 due to contact with the air.

FIG. 2 depicts a front view of a refill dispensing bottle 100 with an extended transfer tube 200, according to an embodiment. FIG. 2 depicts and an example of the bottle 100 (e.g., as shown in FIG. 1) in a deployed configuration.

As discussed above, the transfer nozzle 160 can be connected to the transfer tube 200. The transfer tube 200 can be composed of a flexible plastic that is less rigid than, for example, the transfer nozzle 160 and/or the lid 140. Additionally, the transfer tube 200 is hollow to allow the flowable substance 120 to pass through.

As discussed above, the transfer tube 200 can be stored within the dip tube 150 when the bottle 100 is in a storage configuration (see FIG. 4). In some embodiments, to deploy the transfer nozzle 160, the cap 170 can be removed from the lid 140 (or pivoted open in some embodiments) and the transfer nozzle 160 can be pulled away from the lid 140, which also pulls the attached transfer tube 200 out of the interior of the bottle 100. As discussed above, in various embodiments, the transfer tube 200 and the dip tube 150 can be in a telescopic configuration such that, when being deployed, the transfer tube 200 slides out of the interior of the dip tube 150.

The transfer tube 200 can be flexible and easily bent by a consumer. In some embodiments, the transfer tube 200 can be composed of a plastic that is flexible but also sufficiently rigid to maintain a hollow passageway for the flowable substance 120 even when the transfer tube 200 is bent, as depicted in FIG. 2.

In various implementations, the transfer tube 200 can subsequently be returned to a storage configuration by feeding the transfer tube 200 back in through the hole in the lid 140, such that the transfer tube 200 slides into the interior of the dip tube 150 and returns to a position within the dip tube 150. In various embodiments, the diameter of the hole in the lid 140 may be approximately equal to the outside diameter of the transfer tube 200, and the contact area between the hole in the lid 140 and the outside the transfer tube 200 may form a substantially liquid-tight seal.

FIG. 3 depicts a front view of a refill dispensing bottle 100 and a destination container 300 with the transfer tube 200 extended from the refill dispensing bottle 100 to the destination container 300, according to an embodiment. As shown in FIG. 3, in this configuration the bottle 100 can be used to dispense the flowable substance 120 into the destination container 300, thus filling or refilling the destination container 300.

The destination container 300 can be any type of container that can hold the flowable substance 120, such as, for example, a refillable liquid soap dispenser or the like. For example, the refillable soap dispenser can be designed to hold up to 6 to 10 fluid ounces (180 to 300 cubic cm) of flowable substance, and can include a pump nozzle lid (not shown) connected to a dip tube (not shown) for pumping the liquid soap out of the dispenser, as is well known. The pump nozzle lid and the dip tube can be removed from the dispenser (e.g., by unscrewing the pump nozzle lid from the dispenser) to allow the flowable substance 120 to be dispensed into the destination container 300; e.g., in order to refill the destination container 300.

As shown, the bottle 100 can be in a deployed configuration with the transfer nozzle 160 pulled away from the lid 140 and the transfer tube 200 extended outside of the bottle 100. The transfer nozzle 160 can be placed on top of an opening of the destination container 300. In some embodiments, the transfer nozzle 160 can abut or rest on the opening of the destination container 300 without connecting to the destination container 300. In such embodiments, the transfer nozzle 160 may not include a connection element for connecting the transfer nozzle 160 to a destination container, and either may or may not be held in place by a user's hand (not shown) during use. In other embodiments, the transfer nozzle 160 can include features or devices that enable it to screw, snap, clip, or otherwise connect to the destination container 300.

In some embodiments, the flowable substance 120 can dispensed from the bottle 100 to the destination container 300 by squeezing the bottle 100. Squeezing the bottle 100 can be performed by a user's hand or hands applying pressure to the sidewalls of the body portion 110, including, for example, the wide sidewall 110D and its opposite wide sidewall (not shown), thus elastically deforming the wide side walls inward, which decreases the volume within the bottle 100 and increases the pressure within the bottle 100. The bottle 100 can substantially contain the squeeze-caused pressure within the body portion 110 and around the flowable substance 120, which forces the flowable substance 120 up the dip tube 150, through the transfer tube 200, out of the transfer nozzle 160, and into the destination container 300.

In some implementations, small gaps in between the lid 140 and the narrowed neck portion 130 can allow a small amount of air to pass out of the bottle 100 when the sidewalls are squeezed, such that not all of the squeeze-caused pressure is contained within the bottle 100. In such implementations, because the bottle 100 is not completely sealed, the sidewalls can be by a consumer using a lesser amount of force than that required for implementations in which the bottle is substantially completely or completely sealed.

After an amount of the flowable substance 120 has been dispensed into the destination container 300, the user may release their pressure on the sidewalls (i.e., stop squeezing the bottle 100). When this happens, the elastically flexible sidewalls, including the wide sidewall 110D and its opposite wide sidewall (not shown), will tend to return to their unflexed/undeformed original position, which creates a partial vacuum within the bottle 100. The partial vacuum in the bottle 110 will tend to cause the flowable substance 120 within the transfer nozzle 160 and/or the transfer tube 200 to flow back towards the body portion 110 and, thus, return to the chamber of the body portion 110 of the bottle 100. In implementations that include small gaps in between the lid 140 and the narrowed neck portion 130, this flow back can be reduced or eliminated because air will flow through the gaps and into the bottle 100 more easily than the more viscous flowable substance 120 flows through the transfer tube 200 into the bottle 100. The inflowing air will eliminate the partial vacuum over time, after a small amount (e.g., 0.1-2 fluid ounces) of the flowable substance 120 is sucked back through the transfer nozzle 160 and the transfer tube 200. Thus, the flowable substance 120 will not drip from the transfer nozzle 160 because it has been sucked back at least some distance within the transfer tube 200. For the same purpose as the small gaps in between the lid 140 and the narrowed neck portion 130, some other implementations may employ a one-way valve, for example in the lid 140, that allows air to pass into the bottle 100, but not to pass out of the bottle 100.

Accordingly, the flowable substance 120 can be dispensed from the bottle 100 into the destination container 300 without having to invert the bottle 100 and/or hold the bottle 100 above the destination container 300. In other words, both the bottle 100 and the destination container 300 can be standing upright when the flowable substance 120 is being dispensed. In some embodiments, the bottle 100 can be on the same surface as the destination container 300 during the transfer (e.g., on a countertop). In other embodiments, the bottle 100 can be on a different surface than the destination container 300, the bottle 100 can be at a different height than the destination container 300, and/or the bottle 100, the destination container 300, or both can be held above a surface during the transfer.

Additionally, at least because the transfer nozzle 160 can be in contact with the destination container 300 during transfer and/or at least because the partial vacuum within the bottle 100 can pull back the flowable substance 120 within the transfer nozzle 160 and the transfer tube 200 when pressure is released, the flowable substance 120 can be dispensed from the bottle 100 into the destination container 300 with accuracy and while avoiding or minimizing undesired dispensing of the flowable substance (e.g., by dripping from the transfer nozzle 160 while it is outside of the destination container).

FIG. 4 depicts a cross-sectional front view of a refill dispensing bottle 100 along the plane of line 4-4 in FIG. 1, according to an embodiment.

As described above, when in a storage configuration, (e.g., as shown in FIG. 4), in some implementations, the transfer tube 200, which can be connected to or integral with the transfer nozzle 160, can be contained within the dip tube 150, which can be connected to or integral with the lid 140. In some embodiments, the outside of the transfer tube 200 can abut or substantially contact the interior of the dip tube 150, and the transfer tube 200 and the dip tube 150 can be in a telescopic configuration such that the transfer tube 200 can slide along the interior of the dip tube 150, to create an extended tube that allows the flowable substance 120 to be discharged from the body portion 110 into a destination container. In such implementations, the outside diameter of the transfer tube 200 may be less than or approximately equal to the inside diameter of the dip tube 150.

In some embodiments, when in a storage configuration or a deployed configuration, the dip tube 150 can have a length such that it extends to or near the base portion 110A of the body portion 110 of the bottle 100 (e.g., within about 1-10 mm of the base portion 110A), the dip tube 150 can have a length such that it is in contact with the base portion 110A, or the dip tube 150 can have a length such that it is bent or curved and in contact with the base portion 110A. In still other embodiments, the dip tube 150 may have a length such that it extends only partially towards the base portion 110A (e.g., within about 2-5 cm of the base portion 110A).

Regarding embodiments of the transfer tube, when in a storage configuration, the transfer tube 200 can have a length such that it extends to or near the base portion 110A (e.g., within 1-10 mm of the base portion 110A), the transfer tube 200 can have a length such that it is in contact with the base portion 110A, or the transfer tube 200 can have a length such that it is bent or curved and in contact with the base portion 110A. In still other embodiments, the transfer tube 200 may have a length such that it extends only partially towards the base portion 110A (e.g., within about 2-5 cm of the base portion 110A).

In further embodiments, when in a storage configuration, the transfer tube 200 may have a length such that it extends past the end of the dip tube 150, the transfer tube 200 may have a length such that it extends the same distance from the base portion 110A as the dip tube 150, or the transfer tube 200 may have a length such that it does not extend as far as the dip tube 150 within the bottle 100.

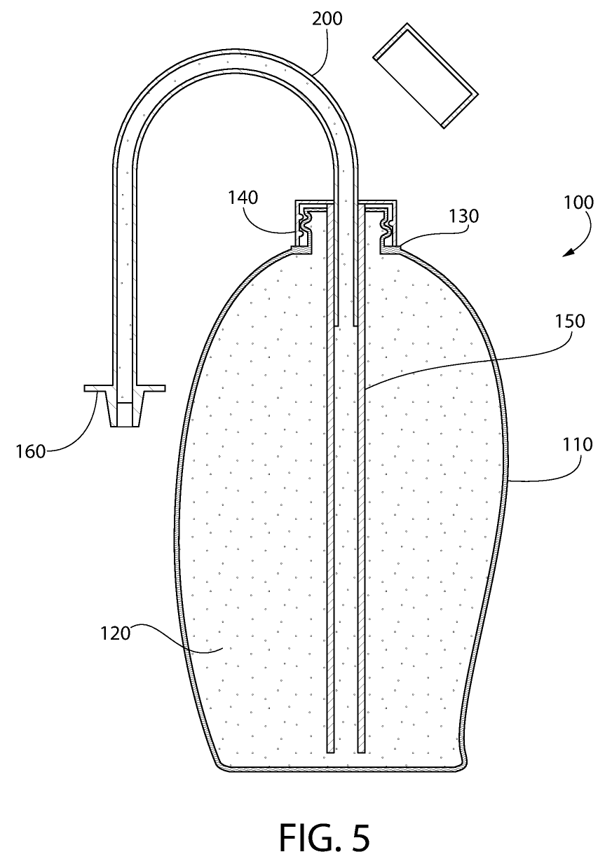

FIG. 5 depicts a cross-sectional front view of a refill dispensing bottle 100 with an extended dispensing tube along the plane of line 5-5 in FIG. 2, according to an embodiment.

As described above, the transfer nozzle 160 can be pulled away from the lid 140 to deploy the transfer nozzle 160 and the transfer tube 200, resulting in a deployed configuration of the bottle 100, (e.g., as shown in FIG. 5).

As previously described, the transfer tube 200 and the dip tube 150 can be in a telescopic configuration.

In various embodiments, when the bottle 100 is in a deployed configuration, the dip tube 150 remains in the same or similar position as when the bottle 100 is in a storage configuration, as shown.

In further embodiments, when the bottle 100 is in a deployed configuration, the transfer tube 200 can remain partially within the dip tube 150, and may be partially withdrawn from the dip tube 150, as shown, compared to when the bottle 100 is in a stored configuration. For example, depending on how far the transfer nozzle 160 is deployed, the transfer tube 200 may extend to the middle of the dip tube 150, may extend to at or near the narrowed neck portion 130 of the bottle 100, or may only extend to at or near the opening in the lid 140.

In some implementations, the end of the transfer tube 200 opposite the transfer nozzle 160 and/or the end of the dip tube 150 near the lid 140 and/or the lid 140 may include a lip, indention, or other stoppage element that prevents the transfer tube 200 from being completely removed from inside the dip tube 150 when deployed. In other words, a consumer may be able to pull the transfer tube 200 out of the dip tube 150 until the stoppage element prevents the transfer tube 200 from being pulled out further.

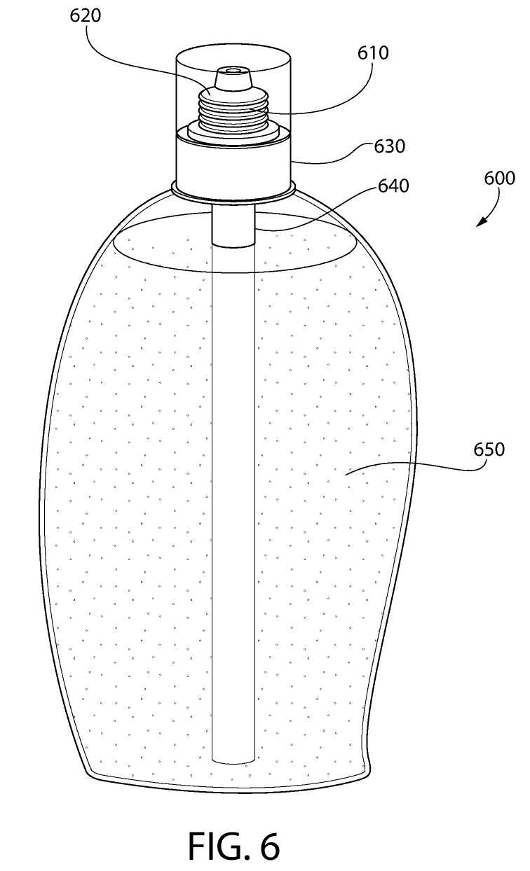

FIG. 6 depicts a front view of a refill dispensing bottle 600, according to an embodiment. The bottle 600 can be similar to the bottle 100, described above. However, in some embodiments, the bottle 600 may not include the transfer tube 200, as described above. Instead, the bottle 600 can include an expandable transfer tube 610.

In some embodiments, the expandable tube 610 can be connected to a transfer nozzle 620 that is the same or similar to the transfer nozzle 160, described above.

The expandable tube 610 can abut, be connected to, or be an integral part of a lid 630 of the bottle 600. In some embodiments, the lid 630 can be the same or similar to the lid 140, described above.

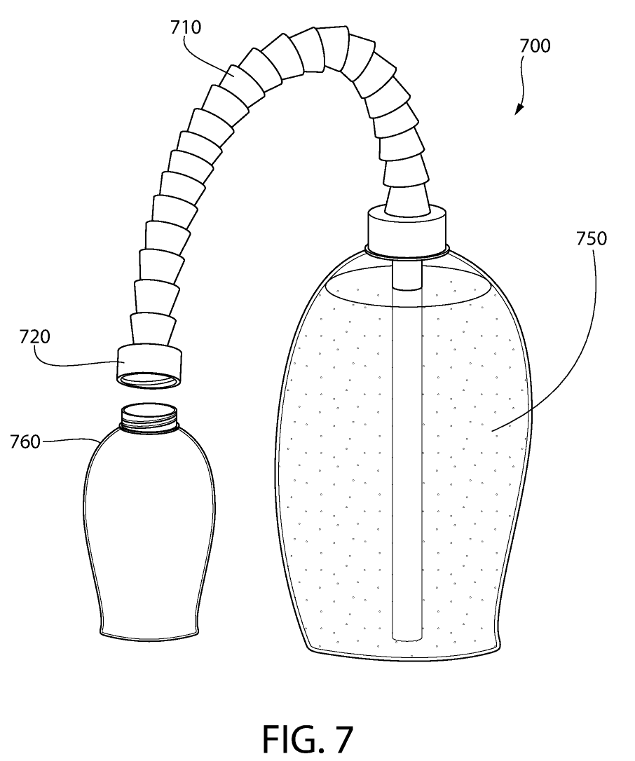

In various embodiments, the expandable tube 610 can be composed of a flexible plastic that can be expanded to extend the expandable tube 610 when the bottle 600 is in a deployed configuration (as shown in FIG. 7) and can be compressed when the bottle 600 is in a storage configuration (as shown in FIG. 6).

In some implementations, the expandable tube 610 can have an articulated and/or concertina-type configuration with two or more sections connected by flexible joints, where the sections can be compressed for compact storage or expanded for deployment.

The expandable tube 610 can be connected or otherwise positioned over a hole in the lid 630 to create a multi-section expandable tube that is fluidly connected with a dip tube 640 for dispensing a flowable substance 650. The expandable tube 610 and the dip tube 640 can form an expanded tube when the expandable tube 610 is expanded. In various embodiments, the dip tube 640 can be the same or similar to the dip tube 150, described above.

To be placed in a deployed configuration, the expandable tube 610 of the bottle 600 can be expanded by, for example, pulling the expandable tube 610 and/or the transfer nozzle 160 away from the lid 630 and in the direction of a destination container. The sections of the expandable tube 610 can expand in a concertina-type manner, and the expandable tube 610, when expanded, can be more flexible than when it is compressed for storage.

FIG. 7 depicts a front view of a refill dispensing bottle 700 with an expandable tube 710 and a destination container 760, according to an embodiment.

The bottle 700 is shown in a deployed configuration and can be similar to the bottle 600, described above. However, in some embodiments, the bottle 700 may not include the transfer nozzle 620, as described above. Instead, the bottle 700 can include a screw cap 720 that is a transfer nozzle, as shown.

When in a deployed configuration, as shown in FIG. 7, the expandable tube 710 of the bottle 700 can be expanded by, for example, pulling the expandable tube 710 in the direction of a destination container (e.g., the destination container 760). The sections of the expandable tube 710 can expand in a concertina-type manner, and the expandable tube 710, when expanded, can be more flexible than the expandable tube 710 when compressed for storage.

The screw cap 720 can have a screw closure design with an interior continuous thread or lugs that allows the screw cap 720 to be screwed onto a destination container (e.g., the destination container 760), such as a refillable soap dispenser with a pump nozzle lid that can be screwed off. The screw cap 720 can be screwed on to the destination container 760 to provide a seal and/or barrier to prevent or minimize the flowable substance 750 from exiting a path from the bottle 700 to the destination container 760. Thus, the screw cap 720 and the expandable tube 710 can provide increased accuracy and avoid or reduce undesired dispensing of the flowable substance (e.g., spillage or dispensing outside of the destination container).

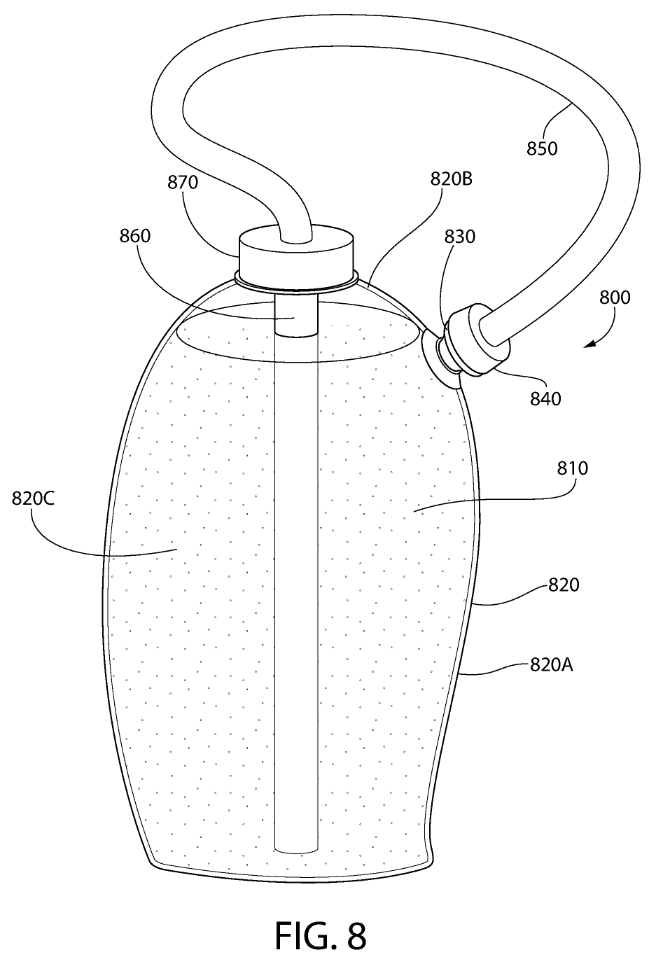

FIG. 8 depicts a front view of a refill dispensing bottle 800, according to an embodiment.

The bottle 800 can contain a flowable substance 810, similar to the flowable substances described above.

The bottle 800 can include a body portion 820, that can be similar to the body portions of the bottles described above, except that the body portion 820 can include a screw cap holder 830 connected to, for example, a narrow sidewall 820A and/or a shoulder portion 820B of the body portion 820. The screw cap holder 830 can be made of plastic. In some embodiments, the screw cap holder 830 can be made of a plastic that is more rigid than, for example, the plastic of a squeezable wide sidewall 820C of the body portion 820.

The screw cap holder 830 can include, for example, a continuous thread or lugs that allows a screw cap 840 to be screwed on when the bottle 800 is in a storage configuration. When the screw cap 840 is screwed onto the screw cap holder 830, an at least partial seal can be created between the screw cap holder 830 and the screw cap 840 that prevents or diminishes exposure of the flowable substance 810 to, for example, air, oxygen, etc., thus preventing or diminishing degradation of the flowable substance 810.

The bottle 800 can include a transfer tube 850 that, unlike the transfer tube 200, described above, may not be in a telescopic configuration with a dip tube 860. In some embodiments, the transfer tube 850 can be connected to the dip tube 860 through a hole in a lid 870, and may define a multi-section tube along with the dip tube 860 for dispensing the flowable substance 810, but the transfer tube 850 may not slide into the dip tube 860 and may remain outside of the body portion 820, even when in a storage configuration.

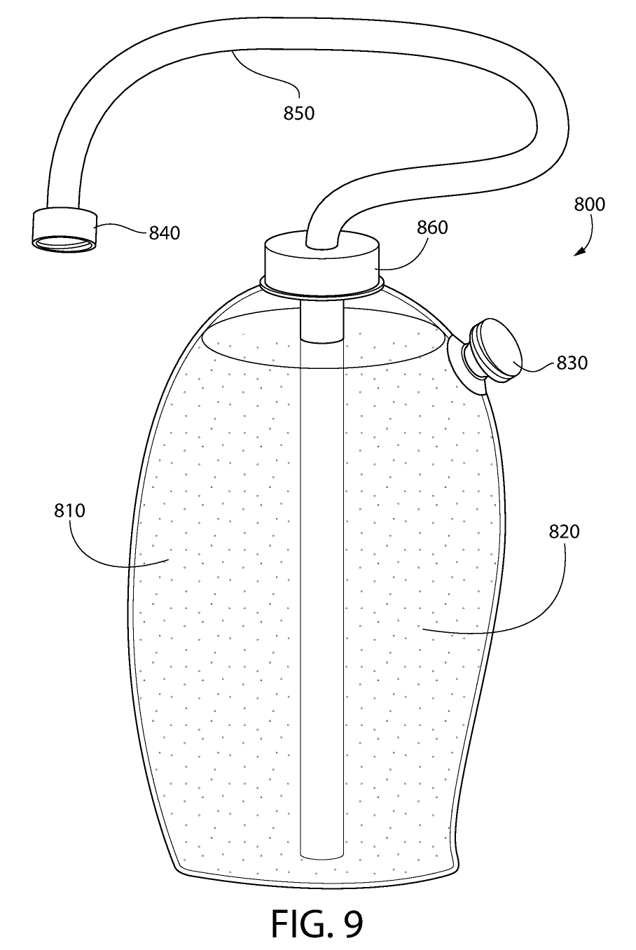

FIG. 9 depicts a front perspective view of the refill dispensing bottle 800, according to an embodiment. FIG. 9 can depict the bottle 800 (e.g., as shown in FIG. 8) in a deployed configuration.

As discussed above, the transfer tube 850 can be stored by screwing the screw cap 840 onto the screw cap holder 830 when the bottle 800 is in a storage configuration. In some embodiments, to deploy the transfer nozzle 850, the screw cap 840 can be unscrewed from the screw cap holder 830, and can be positioned towards a destination container.

The top of the screw cap holder 830 can be formed such that it does not include a hole. Thus, the flowable substance 810 may not pass through screw cap holder 830 and may only be dispensed or otherwise exit the body portion 810 via the narrowed neck portion 860.

In some implementations, the transfer tube 850 can subsequently be returned to a storage configuration by screwing the screw cap 840 back onto the screw cap holder 830, and the transfer tube 850 may remain outside of the body portion 820 of the bottle 800, as shown in FIG. 8.

Accordingly, the refill dispensing bottles can dispense a liquid, fluid, or other flowable substance without having to hold the refill dispensing bottle in an inverted state, can dispense a flowable substance without having to hold the refill dispensing bottle over a destination container, and/or can dispense a flowable substance while avoiding or minimizing undesired dispensing of the flowable substance (e.g., spillage or drippage outside of the destination container).

What is claimed is:

1. A container for a flowable substance, comprising:
a body portion comprising sidewalls that form a chamber for containing the flowable substance;
a neck portion that is connected to the body portion;
a lid that is connected to the neck portion and that defines a hole;
a dip tube that is connected to the lid and the hole and that is positioned within the body portion;
a transfer tube; and
a transfer nozzle connected to the transfer tube;
wherein the dip tube and the transfer tube form an expanded tube when the transfer tube is extended; and
wherein when pressure is applied to the sidewalls of the body portion, the flowable substance flows from the chamber into an interior of the expanded tube and is discharged via the transfer nozzle.

2. The container of claim 1, wherein the transfer tube:
passes through the hole;
is configured to slide in and out of the dip tube; and
is extended when the transfer tube is slid out of the dip tube.

3. The container of claim 1, wherein the transfer tube:
is expandable;
is connected to the lid; and
is extended when an end of the transfer tube is pulled away from the lid.

4. The container of claim 1, wherein the transfer nozzle is a screw cap transfer nozzle.

5. The container of claim 1, wherein the lid comprises a continuous inside thread or lugs that allows the lid to be screwed on to the neck portion.

6. The container of claim 1, wherein the dip tube extends to within 10 millimeters of a base portion of an interior of the body portion.

7. The container of claim 1, whereby the flowable substance is discharged into a destination container that is configured to hold a smaller volume of the flowable substance than the container.

8. The container of claim 1, wherein the container remains upright while the flowable substance is discharged.

9. The container of claim 1, whereby, when the pressure is released from the sidewalls, an amount of the flowable substance in the transfer tube flows back into the body portion.

10. A container for a flowable substance, comprising:
a body portion comprising sidewalls that form a chamber for containing the flowable substance;
a neck portion that is connected to the body portion;
a lid that is connected to the neck portion and that defines a hole;
a dip tube that is connected to the lid and the hole and that is positioned within the body portion;
a transfer tube connected to the lid and the hole;
a screw cap transfer nozzle connected to the transfer tube; and
a screw cap holder connected to the body portion;
wherein the transfer tube is stored when the screw cap transfer nozzle is screwed to the screw cap holder and the transfer tube is deployed when the screw cap transfer nozzle is unscrewed from the screw cap holder; and
wherein when the transfer tube is deployed and pressure is applied to the sidewalls, the flowable substance flows from the chamber into an interior of the dip tube and the transfer tube and is discharged via the screw cap transfer nozzle.

11. The container of claim 10, wherein the lid comprises a continuous inside thread or lugs that allows the lid to be screwed on to the neck portion.

12. The container of claim 10, wherein the dip tube extends to within 10 millimeters of a base portion of an interior of the body portion.

13. The container of claim 10, whereby the flowable substance is discharged into a destination container that is configured to hold a smaller volume of the flowable substance than the container.

14. The container of claim 10, wherein the container remains upright while the flowable substance is discharged

15. The container of claim 10, whereby, when the pressure is released from the sidewalls, an amount of the flowable substance in the transfer tube flows back into the body portion.
